(19) United States
(12) Patent Application Publication
(10) Pub. No.: US 2013/0117774 A1
(43) Pub. Date: May 9, 2013

(54) SECURE BROADCAST AREA IDENTIFICATION

(71) Applicants: Jack F. Perry, II, Marion, IA (US); Steven C. Maher, Marion, IA (US)

(72) Inventors: Jack F. Perry, II, Marion, IA (US); Steven C. Maher, Marion, IA (US)

(73) Assignee: SYNCBAK, INC., Marion, IA (US)

(21) Appl. No.: 13/547,831

(22) Filed: Jul. 12, 2012

Related U.S. Application Data
(63) Continuation-in-part of application No. 13/288,364, filed on Nov. 3, 2011.

(51) Int. Cl. H04N 21/80

(52) U.S. Cl. 725/14

(57) ABSTRACT

Systems, methods, apparatus, and computer program products are provided for receiving content available for consumption. For example, in one embodiment, an electronic device can provide location information to a management server that can be validated as originating from a trusted source of the electronic device. The management server can then validate the location information and determine the appropriate broadcast area for the electronic device based at least in part on the location information.

### CROSS-REFERENCE TO RELATED APPLICATIONS

This application is a continuation-in-part of U.S. patent application Ser. No. 13/288,364 filed on Nov. 03, 2011, which is hereby incorporated herein in its entirety by reference.

### BACKGROUND

At present, there are over 700 major network television affiliates, 1,600 smaller network television affiliates, and 3,000 community broadcasters across the United States. Currently, these broadcasters are unable to provide their broadcasts, for example, via the Internet because of regulations limiting consumption to users located within their respective broadcast areas. Broadcasters, therefore, need a solution that will allow them to deliver their broadcasts (and/or other content) via the Internet to users located (or having a presence) within or proximate their respective broadcast areas.

### BRIEF SUMMARY

In general, embodiments of the present invention provide systems, methods, apparatus, and computer program products for identifying a broadcast area and for receiving content available for consumption.

In accordance with one aspect, a method for receiving content available for consumption is provided. In one embodiment, the method comprises (1) providing location information associated with an electronic device, wherein the location information (a) identifies the location of the electronic device, (b) is used to identify a broadcast area associated with the electronic device, and (c) is provided to allow validation as originating from a trusted source of the electronic device; (2) generating a request for content associated with the broadcast area; and (3) receiving the requested content.

In accordance with another aspect, an apparatus comprising at least one processor and at least one memory including computer program code is provided. In one embodiment, the at least one memory and the computer program code may be configured to, with the processor, cause the apparatus to at least (1) provide location information associated with an electronic device, wherein the location information (a) identifies the location of the electronic device, (b) is used to identify a broadcast area associated with the electronic device, and (c) is provided to allow validation as originating from a trusted source of the electronic device; (2) generate a request for content associated with the broadcast area; and (3) receive the requested content.

In accordance with yet another aspect, a computer program product for receiving content available for consumption is provided. The computer program product may comprise at least one computer-readable storage medium having computer-readable program code portions stored therein, the computer-readable program code portions comprising executable portions configured to (1) provide location information associated with an electronic device, wherein the location information (a) identifies the location of the electronic device, (b) is used to identify a broadcast area associated with the electronic device, and (c) is provided to allow validation as originating from a trusted source of the electronic device; (2) generate a request for content associated with the broadcast area; and (3) receive the requested content.

In accordance with one aspect, a method for identifying a broadcast area is provided. In one embodiment, the method comprises (1) receiving location information associated with an electronic device, wherein the location information identifies the location of the electronic device; (2) validating the location information as originating from a trusted source of the electronic device; and (3) identifying a broadcast area associated with the electronic device based at least in part on the location information.

In accordance with another aspect, an apparatus comprising at least one processor and at least one memory including computer program code is provided. In one embodiment, the at least one memory and the computer program code may be configured to, with the processor, cause the apparatus to at least (1) receive location information associated with an electronic device, wherein the location information identifies the location of the electronic device; (2) validate the location information as originating from a trusted source of the electronic device; and (3) identify a broadcast area associated with the electronic device based at least in part on the location information.

In accordance with still another aspect, a computer program product for identifying a broadcast area is provided. The computer program product may comprise at least one computer-readable storage medium having computer-readable program code portions stored therein, the computer-readable program code portions comprising executable portions configured to (1) receive location information associated with an electronic device, wherein the location information identifies the location of the electronic device; (2) validate the location information as originating from a trusted source of the electronic device; and (3) identify a broadcast area associated with the electronic device based at least in part on the location information.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice various embodiments of the present invention.

FIG. 2 is an exemplary schematic of a broadcast system according to one embodiment of the present invention.

FIG. 3 is an exemplary schematic of a local device according to one embodiment of the present invention.

FIG. 4 is an exemplary schematic of a management server according to one embodiment of the present invention.

FIG. 5 is an exemplary schematic of a remote device according to one embodiment of the present invention.

FIG. 6 shows broadcast areas served by broadcast systems according to one embodiment of the present invention.

FIGS. 7 and 8 are flowcharts illustrating operations and processes that can be used in accordance with various embodiments of the present invention.

FIGS. 9 and 10 show exemplary input and output (including user interactions) that can be produced in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. Like numbers refer to like elements throughout. The term “exemplary” is used to be an example with no indication of quality level.

I. Methods, Apparatus, Systems, and Computer Program Products

As should be appreciated, various embodiments may be implemented in various ways, including as methods, apparatus, systems, or computer program products. Accordingly, various embodiments may take the form of an entirely hardware embodiment or an embodiment in which a processor is programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

II. Exemplary System Architecture

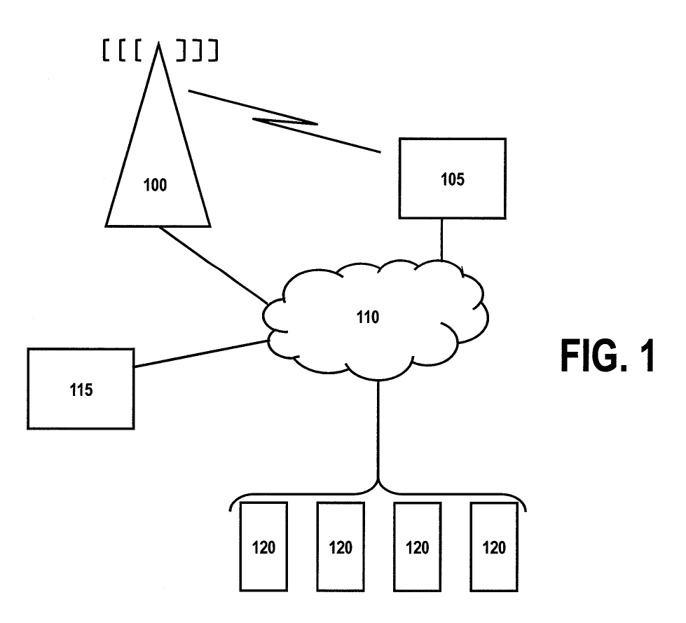

FIG. 1 provides an illustration of a system that may be used in conjunction with various embodiments of the present invention. As shown in FIG. 1, the system may include one or more broadcast systems 100, one or more local devices 105, one or more networks 110, one or more management servers 115, and one or more remote devices 120. Each of the components of the system may be in electronic communication with, for example, one another over the same or different wireless or wired networks including, for example, a wired or wireless Personal Area Network (PAN), Local Area Network (LAN), Metropolitan Area Network (MAN), Wide Area Network (WAN), and/or the like. Additionally, while FIG. 1 illustrates certain system entities as separate, standalone entities, the various embodiments are not limited to this particular architecture.

1. Broadcast System

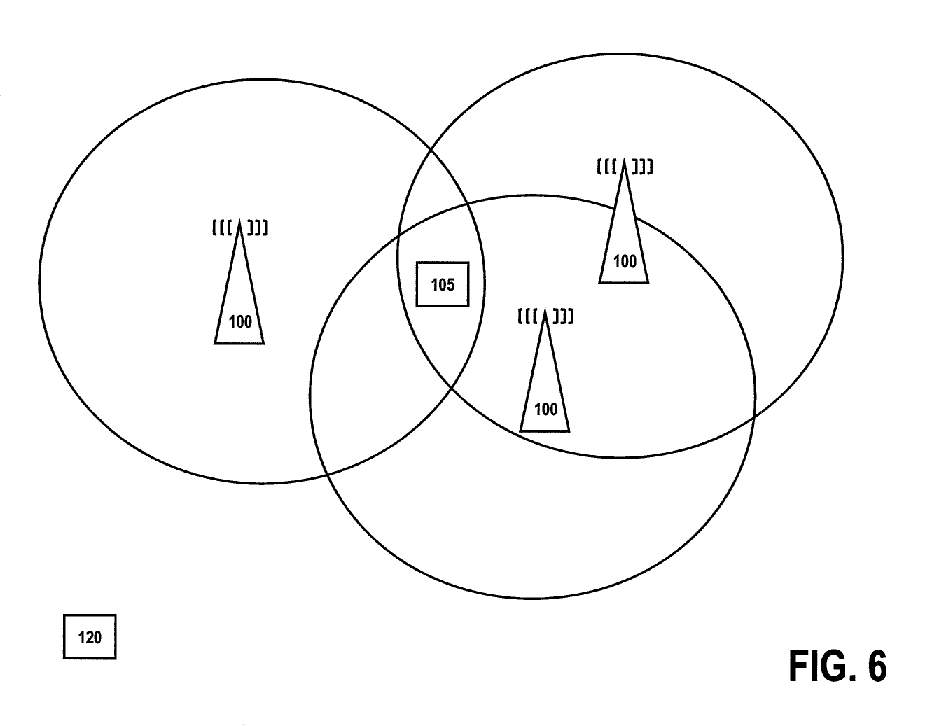

Embodiments of the present invention may be used in combination with a variety of broadcast systems 100. For example, a broadcast system 100 may be, for example, an over-the-air broadcast system, a cable broadcast system, a satellite broadcast system, and/or a variety of other systems for transmitting broadcasts (see FIG. 6).

a. Over-the-Air Broadcast System

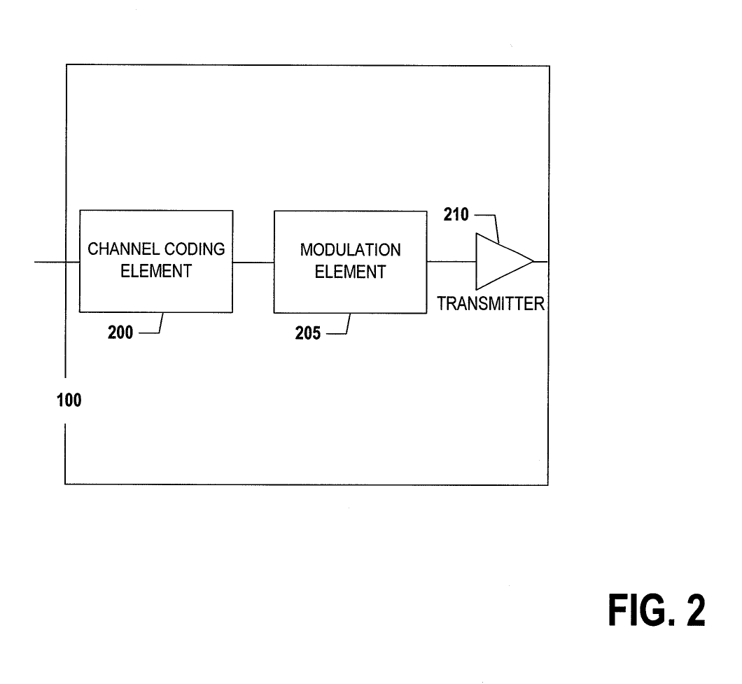

FIG. 2 provides an exemplary schematic representative of an over-the-air (OTA) broadcast system 100 that can be used in conjunction with embodiments of the present invention.

The OTA broadcast system 100 may be owned and/or operated by a broadcaster (e.g., KCRG-TV9) and associated with a broadcast area (e.g., Cedar Rapids, Iowa or the Atlanta, Georgia metropolitan area). Broadcasters may have rights to distribute content within broadcast areas (e.g., within local, regional, or other geographic service areas), such as free-to-air television or free-to-view television. As will be recognized, a broadcaster may have one or more OTA broadcast systems 100 depending on the geographic area (e.g., designated market area (DMA), zip code, block group, census tract, and government-established area/zone) the broadcast area includes. An OTA broadcast system 100 may include various components to broadcast/transmit content and/or data via an OTA broadcast (e.g., an OTA broadcast signal). As shown in FIG. 2, in one embodiment, the OTA broadcast system 100 may include a channel coding element 200, a modulation element 205, and a transmitter 210. Although not shown, the OTA broadcast system 100 may also include various other components, such as audio subsystems, video subsystems, multiplexers, exciters, drivers, amplifiers, network interfaces, processing elements, and/or the like. Via these elements, for instance, the OTA broadcast system 100 can broadcast/transmit OTA broadcasts within a broadcast area (e.g., transmit broadcast signals in a one-to-many configuration). The OTA broadcast system 100 may transmit the broadcast (e.g., OTA broadcast) using a variety of standards and protocols, such as Advanced Television Systems Committee (ATSC), Terrestrial Integrated Services Digital Broadcasting (ISDB-T), Terrestrial Digital Multimedia Broadcasting (T-DMB), Digital Video Broadcasting-Terrestrial (DVB-T), Digital Video Broadcasting-Handheld (DVB-H), Satellite Terrestrial Interactive Multi-service Infrastructure (STiMi), National Television System Committee (NTSC) standards and protocols, and/or the like.

As indicated, the broadcast (e.g., OTA broadcast) may include both content and data. Generally, the term “content” may refer to any type of media, whether audio, video, text, and/or the like. For example, content may include television broadcasts (e.g., live local newscasts), television programs (e.g., The Office), movies (e.g., video-on-demand (VOD)), datacasts, music, images, videos, text, webpages, and/or the like. The term “data” may refer to any type of data, including ancillary data, control data, conditional access control data, data associated with program audio and/or video services (e.g., closed captioning), and/or the like.

Although not shown, the OTA broadcast system 100 (or other broadcast facility located proximate or remote from the OTA broadcast system 100) may also comprise one or more components for providing content to local and remote devices 105, 120 via a network such as the Internet. These components may include VOD systems, Internet broadcast systems, content servers, and/or the like. Thus, via such components, a broadcaster can provide a variety of content (e.g., linear and non-linear media) via the Internet to local and remote devices 105, 120.

It will be appreciated that one or more of the broadcast system's 100 components and other broadcaster components may be located remotely from one another. Furthermore, one or more of the components may be combined and additional components performing functions described herein may be included.

b. Cable Broadcast System

Although not shown, a cable broadcast system (also referred to as a broadcast system) may be used with embodiments of the present invention. A cable broadcast system may include various components to broadcast/transmit content and/or data via the cable provider's broadcast system to the cable provider's subscribers. For example, in various embodiments, the cable broadcast system may include a network operations center, a cable modem termination system, and a headend to transmit cable broadcasts (e.g., digital cable signals) through the cable provider's distribution network to local devices 105, which may include set-top boxes and/or cable modems. Thus, the set-top boxes (and/or local devices 105) may communicate with a headend over a distribution network. For example, the headend may route messages (e.g., subscriber inputs) received from the set-top boxes (and/or local devices 105) to various components of the cable provider's broadcast system and broadcast/transmit content (e.g., selected programs) to the set-top boxes.

To perform such functions, the cable broadcast system may include various components, such as audio subsystems, video subsystems, multiplexers, switches, encoders satellite receivers and antennae, network interfaces, decoding elements, encoding elements, processing elements, transmitting elements, modulation elements, and/or the like. The cable broadcast system may be capable of receiving and transmitting content and data using a variety of standards and protocols such as those described with regard to the OTA broadcast system 100, including data over cable service interface specification (DOCSIS).

c. Satellite Broadcast System

Although not shown, a satellite broadcast system (also referred to as a broadcast system) may be used with embodiments of the present invention. A satellite broadcast system may include various components to broadcast/transmit content and/or data via the satellite provider's broadcast system to the satellite provider's subscribers. For example, in various embodiments, the satellite broadcast system may include uplink facilities (with transmitting antennae), satellites (with transponders), receiving satellite dishes, and/or local devices 105. Thus, the satellite broadcast system can broadcast/transmit satellite broadcasts to subscribers, such as direct broadcast satellite (DBS), television receive only (TVRO), and/or the like. The satellite broadcast system may be capable of receiving and transmitting content and data using a variety of standards and protocols, such as those described with regard to the OTA broadcast system 100.

2. Local Device

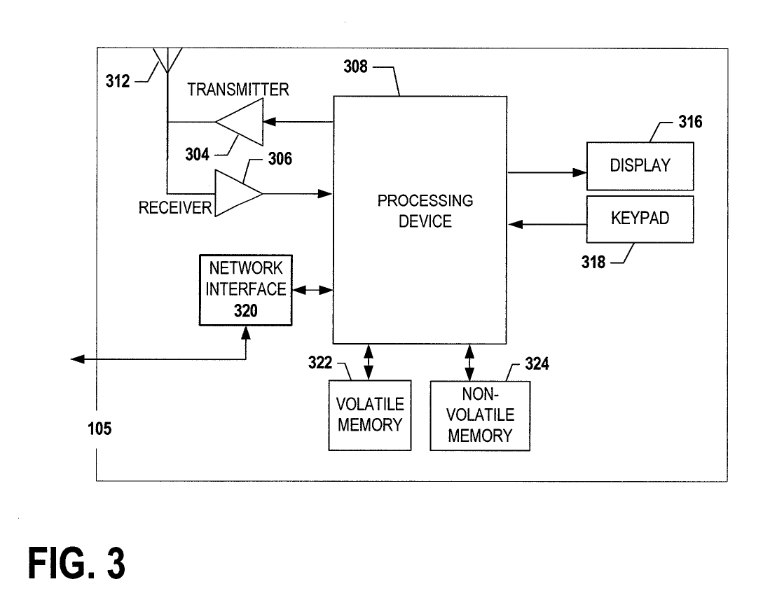

FIG. 3 provides an exemplary schematic representative of a local device 105 (e.g., an electronic device) that can be used in conjunction with embodiments of the present invention, such as a computing device or television. In general, the term “local device” may refer to, for example, a device located within a specific broadcast area (e.g., a device located within a broadcaster's broadcast area, which may be a town, a city, a metropolitan area, a state, a region, a country, and/or the like). As shown in FIG. 3, the local device 105 may include an antenna 312, a transmitter 304, a receiver 306, a network interface 320, tuner or tuner card (not shown), and a processing device 308 (e.g., a processor, controller, and/or the like) that provides signals to the transmitter 304 (and/or network interface 320) and receives signals from receiver 306 (and/or network interface 320).

The signals provided to the transmitter 304 (and/or network interface 320) and received from the receiver 306 (and/or network interface 320) may include signaling information in accordance with an air interface standard of applicable wireless systems. In this regard, the local device 105 may be capable of operating with one or more air interface standards, communication protocols, modulation types, and access types. More particularly, the local device 105 may operate in accordance with any of a number of second-generation (2G), third-generation (3G), fourth-generation (4G), ATSC, ISDB-T, T-DMB, DVB-T, DVB-H, STiMi standards and protocols, and/or the like. Further, for example, the local device 105 may operate in accordance with any of a number of different wireless networking techniques, such as 802.11, general packet radio service (GPRS), Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), IEEE 802.11 (Wi-Fi), 802.16 (WiMAX), ultra wideband (UWB), infrared (IR) protocols, Bluetooth protocols, wireless universal serial bus (USB) protocols, and/or any other wireless protocol. The local device 105 may also operate in accordance with a variety of wired networking standards and protocols. Via these communication standards and protocols, the local device 105 can communicate with the management server 115, for example, and/or receive broadcasts/transmissions from the broadcast system 100. The local device 105 can also download changes, add-ons, and updates, for instance, to its firmware, software (e.g., including modules), and operating system.

The local device 105 may also comprise a user interface (that can include a display 316 coupled to a processing device 308) and/or a user input interface (coupled to the processing device 308). The user input interface can comprise any of a number of devices allowing the local device 105 to receive input and/or data, such as a keypad 318, a touch display, voice or motion interfaces, or other input device such as a remote control. The local device 105 can also include volatile memory 322 and/or non-volatile memory 324, which can be embedded and/or may be removable. For example, the non-volatile memory may be embedded or removable MMCs, SD memory cards, Memory Sticks, EEPROM, flash memory, hard disk, or the like. The memory can store any of a number of pieces or amount of information and data used by the local device 105 to implement the functions of the local device 105. The memory can also store content, such as program code for an application and/or other programs.

In one embodiment, the local device 105 may be adapted to determine its location using a location-determining solution. For example, the location-determining solution can acquire location information/data, such as latitude, longitude, altitude, and/or geocode information/data. In one embodiment, the location-determining solution of a local device 105 can acquire information/data, sometimes known as ephemeris information/data, by identifying the number of satellites (e.g., Low Earth Orbit (LEO) satellite system or a Department of Defense (DOD) satellite system) in view and the relative positions of those satellites. Additionally or alternatively, the local device 105 may determine its location via triangulation in connection with various communication points (e.g., cellular towers or Wi-Fi access points) positioned at various locations throughout a geographic area.

In one embodiment, the local device 105 can also perform and support various encryption and decryption methods and techniques. Such encryption and decryption methods and techniques can be performed at various levels. For example, in one embodiment, for at least some instances, location information/data can be encrypted at the hardware level. In other instances, location information/data can be encrypted at a higher level such as by various applications, modules, and interfaces. As will be recognized, a variety of approaches and techniques can be used to adapt to various needs and circumstances.

3. Management Server

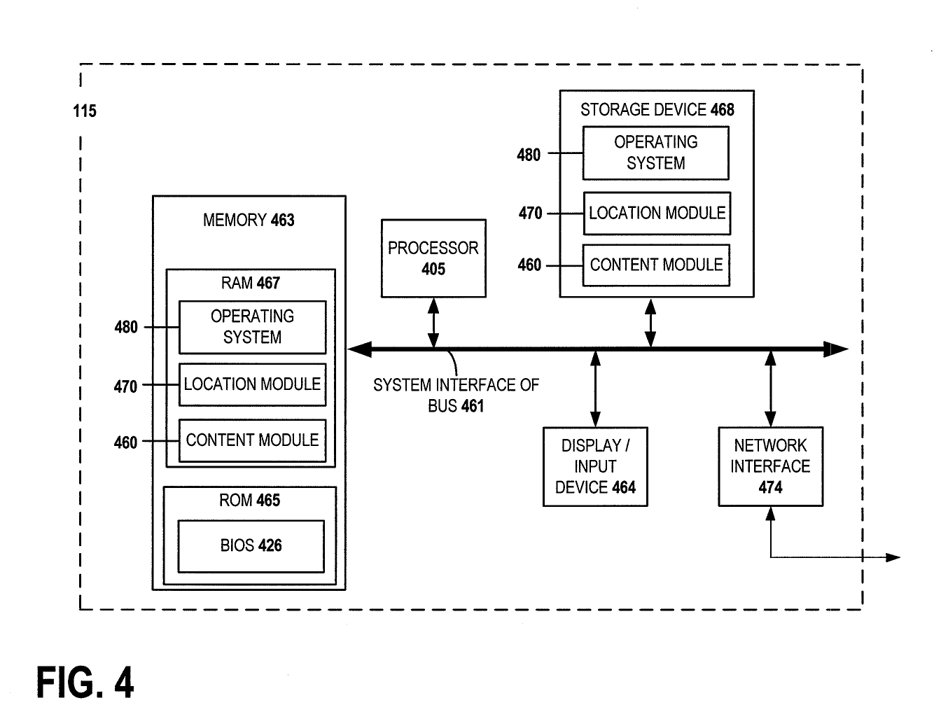

FIG. 4 provides an exemplary schematic of a management server 115 according to one embodiment of the present invention. In general, the term “management server” may refer to, for example, any computer, computing device, gaming console mobile phone, desktop, notebook or laptop, distributed system, broadcast system, server, blade, gateway, switch, or other processing device adapted to perform the functions described herein. As will be understood from this figure, in this embodiment, the management server 115 may include a processor 405 that communicates with other elements within the management server 115 via a system interface or bus 461. The processor 405 may be embodied in a number of different ways. For example, the processor 405 may be embodied as a processing element, a coprocessor, a controller or various other processing devices including integrated circuits such as, for example, an application specific integrated circuit (ASIC), a field programmable gate array (FPGA), a hardware accelerator, or the like.

In an exemplary embodiment, the processor 405 may be configured to execute instructions stored in the device memory or otherwise accessible to the processor 405. As such, whether configured by hardware or other methods, or by a combination thereof, the processor 405 may represent an entity capable of performing operations according to embodiments of the present invention while configured accordingly. A display device/input device 464 for receiving and displaying content and/or data may also be included in the management server 115. This display device/input device 464 may be, for example, a keyboard or pointing device that is used in combination with a monitor. The management server 115 further may include memory 463, which may include both read only memory (ROM) 465 and random access memory (RAM) 467. The management server's ROM 465 may be used to store a basic input/output system (BIOS) 426 containing the basic routines that help to transfer information to the different elements within the management server 115.

In addition, in one embodiment, the management server 115 may include at least one storage device 468, such as a hard disk drive, a CD drive, and/or an optical disk drive for storing information on various computer-readable media. The storage device(s) 468 and its associated computer-readable media may provide nonvolatile storage. The computer-readable media described above could be replaced by any other type of computer-readable media, such as embedded or removable multimedia memory cards (MMCs), secure digital (SD) memory cards, Memory Sticks, electrically erasable programmable read-only memory (EEPROM), flash memory, hard disk, or the like. Additionally, each of these storage devices 468 may be connected to the system bus 461 by an appropriate interface.

Furthermore, a number of executable instructions, applications, scripts, program modules, and/or the like may be stored by the various storage devices 468 and/or within RAM 467. Such executable instructions, applications, scripts, program modules, and/or the like may include an operating system 480, a location module 470, and a content module 460. These modules may control certain aspects of the operation of the management server 115 with the assistance of the processor 405 and operating system 480—although their functionality need not be modularized. In addition to the program modules, the management server 115 may store or be connected to one or more databases with one or more tables stored therein.

Also located within the management server 115, in one embodiment, is a network interface 474 for interfacing with various computing entities, including the broadcast system 100. This communication may be via the same or different wired or wireless networks (or a combination of wired and wireless networks). For instance, the communication may be executed using a wired data transmission protocol, such as fiber distributed data interface (FDDI), digital subscriber line (DSL), Ethernet, asynchronous transfer mode (ATM), frame relay, DOCSIS, or any other wired transmission protocol. Similarly, the management server 115 may be configured to communicate via wireless external communication networks using any of a variety of protocols, such as 802.11, general packet radio service (GPRS), wideband code division multiple access (W-CDMA), or any other wireless protocol (including those described above). Via these communication standards and protocols, the management server 115 can communicate with the local devices 105, remote devices 120, and broadcast systems 100. The management server 115 may also include receivers (not shown), transmitters (not shown), and other components (not shown) capable of operating in accordance with ATSC, ISDB-T, T-DMB, DVB-T, DVB-H, STiMi standards and protocols, and/or the like.

It will be appreciated that one or more of the management server's 115 components may be located remotely from other management server 115 components. Furthermore, one or more of the components may be combined and additional components performing functions described herein may be included in the management server 115. Moreover, the physical location and operation of the management server 115 may vary. For example, in one embodiment, the management server 115 may be operated by a party independent of the broadcaster and located remote from the broadcast system 100. In another embodiment, the management server 115 may be operated by a broadcaster, with the management server 115 being located at a broadcast facility such as the broadcast system 100. Moreover, there may be multiple management servers 115 in geographically distinct locations.

4. Remote Device

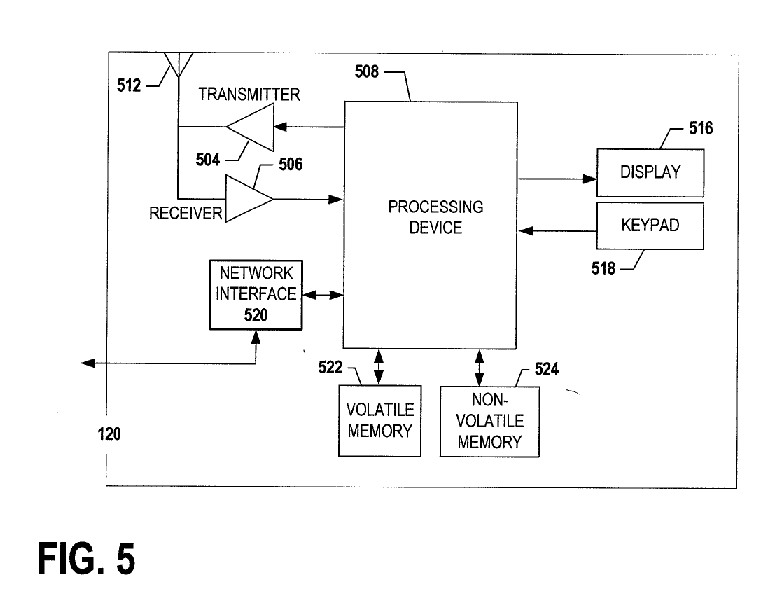

FIG. 5 provides an exemplary schematic representative of a remote device 120 (e.g., an electronic device) that can be used in conjunction with embodiments of the present invention, such as a computing device or television. In general, the term “remote device” may refer to, for example, a device located outside a specific broadcast area when attempting to access content associated with the broadcast area (e.g., a device located outside a broadcaster's broadcast area when attempting to access the broadcaster's content). Although, in certain embodiments, the remote device 120 may also be located within a broadcaster's broadcast area when attempting to access the broadcaster's content. As shown in FIG. 5, the remote device 120 may include an antenna 512, a transmitter 504, a receiver 506, a network interface 520, tuner or tuner card (not shown), and a processing device 508 (e.g., a processor, controller, and/or the like) that provides signals to and receives signals from the transmitter 504 (and/or network interface 520) and receiver 506 (and/or network interface 520).

The signals provided to the transmitter 504 (and/or network interface 520) and received from the receiver 506 (and/or network interface 520) may include signaling information in accordance with an air interface standard of applicable wireless systems (or wired systems). For example, the remote device 120 may be capable of operating with one or more standards, communication protocols, modulation types, and access types as described above with respect to the local device 105.

The remote device 120 may also comprise a user interface (that can include a display 516 coupled to a processing device 508) and/or a user input interface (coupled to the processing device 508). The user input interface can comprise any of a number of devices allowing the remote device 120 to receive input and/or data, such as a keypad 518, a touch display, voice or motion interfaces, or other input device. The remote device 120 can also include volatile memory 522 and/or non-volatile memory 524, which can be embedded and/or may be removable as described above with respect to the local device 105. The memory can store any of a number of pieces or amount of information/data used by the remote device 120, such as program code for an application and/or other programs.

III. Broadcast Area Identification/Determination

The described examples for broadcast area identification/determination are provided for illustrative purposes only and should not be taken in any way as limiting embodiments of the present invention to the examples provided. As indicated, a broadcast area may correspond to one or more DMAs, which can be used to identify the television offerings in the broadcast area. A broadcast area, though, may also correspond to a variety of other types of geographic areas, such as block groups, zip codes, census tracts, government-established areas/zones, cartographic levels, and/or the like.

1. User Registration

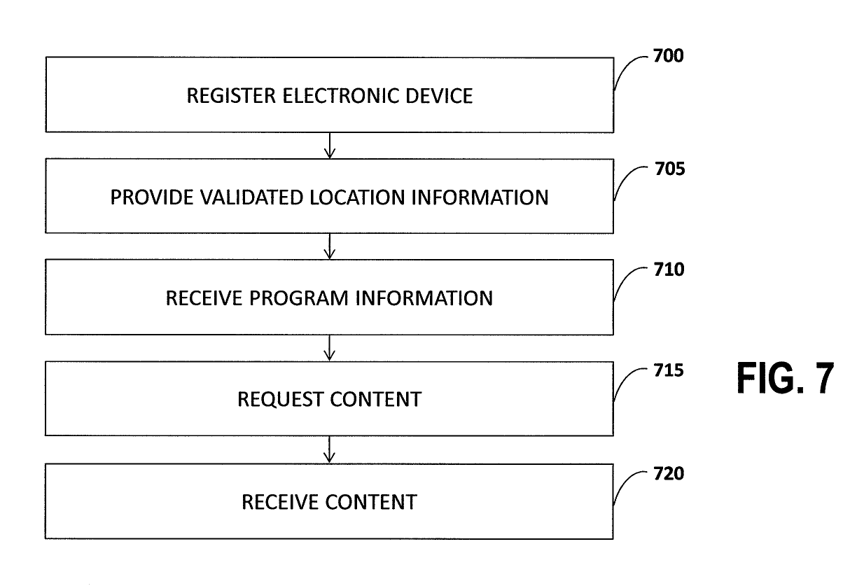

In one embodiment, the process may begin by a local device 105 (e.g., via a user operating a local device 105) generating a request to register a user to access a broadcaster's content via a network such as the Internet (Block 700 of FIG. 7). The request may be a request, for example, to register the user directly with a specific broadcaster (e.g., KCRG-TV9, Comcast, DISH Network) or an independent third party representing multiple broadcasters (e.g., www.syncbak.com). In one embodiment, the request to register the user may be executed via a module, program, or application that has been downloaded or preinstalled (e.g., is resident) on the local device 105. In another embodiment, the request to register the user may be generated via a webpage of a broadcaster or an independent third party.

In one embodiment, the request to register the user may include user information. The user information may include a variety of information associated with the user and/or the local device 105. For example, the user information may include (a) the user's first and last name, (b) the user's address, (c) the user's zip code, (d) the user's telephone number, (e) a username, (f) a charge card number, (g) a local device identifier (e.g., Subscriber Identity Module (SIM) number, Media Access Control (MAC) address, International Mobile Subscriber Identity (IMSI) number, an Internet Protocol (IP) address, mobile equipment identifier (MEID)), and/or (h) the like. The user information may be used to uniquely identify the user and/or the local device 105.

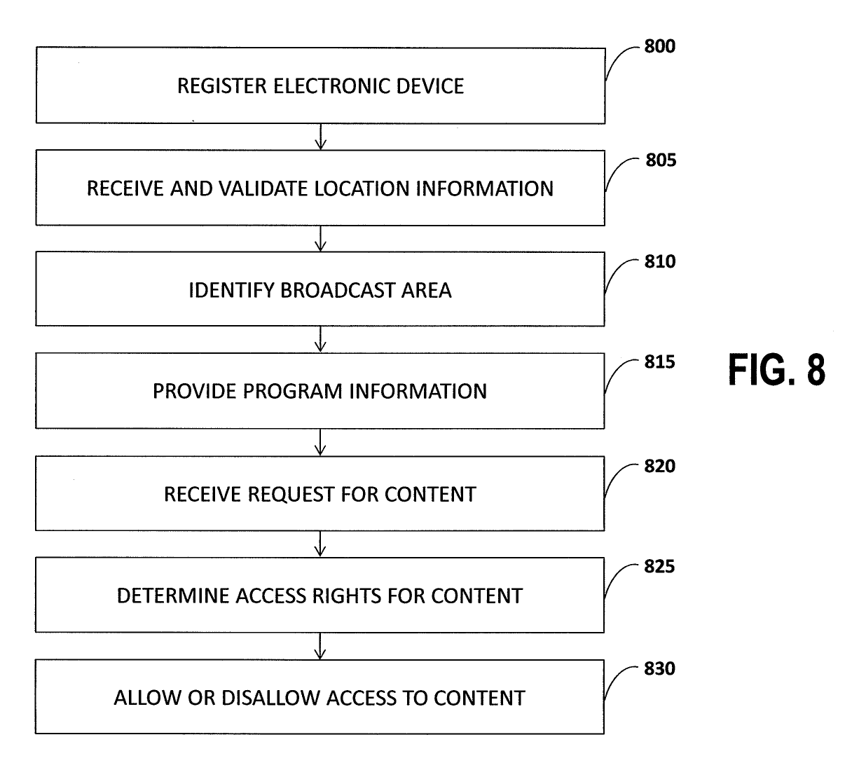

In one embodiment, the request to register the user can be sent to and received by a management server 115 (Block 800 of FIG. 8). As previously discussed, the physical location and operation of the management server 115 may vary. For example, the management server 115 may be operated by a broadcaster or an independent third party. Irrespective of ownership and/or operation, in response to (e.g., after) receiving the request to register the user, the management server 115 can create a user account with the user information and electronically store at least a portion of the user information in association with the user account.

It should be noted that in various embodiments, the user account may be used to not only store information associated with the user and the local device 105, but information associated with additional local devices 105 (e.g., a personal computer and a television in the user's home) and/or remote devices 120. The user account and/or user information may be used to provide content to the local device 105 and/or remote device 120 via the Internet (or other wired or wireless network). In one embodiment, to provide content from the broadcaster to the local device 105 and/or remote device 120 via the Internet, for example, the local device 105 can be used to determine/identify the broadcast area (e.g., DMA, zip code, block group, census tract, and government-established area/zone) in which the local device 105 is located or associated.

2. Location Information/Data Validation and Broadcast Area Determination/Identification

In one embodiment, after registration, a local device 105 can be used to access content available for consumption. For example, in one embodiment, the local device 105 can request program information (to the local device 105 and/or remote device 120) for the broadcast area in which the local device 105 is located. In another embodiment, the local device 105 may request content that is known to be available for consumption. To do so, a user operating the local device 105 can access an application, for example, executing on the local device 105 that can be used to access both program information and content to the local device 105.

a. Location Information/Data Validation

On a periodic basis, regular basis, continuous basis, and/or in response to (e.g., after) certain triggers or requests, the local device 105 (e.g., GPS, location module 470, application executing on the local device 105) can provide location information/data to the management server 115. For instance, in one embodiment, each time the application executing on the local device 105 begins execution, the local device 105 can request program information from the management sever 115 that in turn requests location information/data from the local device 105. In another embodiment, each time the application executing on the local device 105 begins execution, the local device 105 may attempt to communicate with the management server 115 that in turn requests location information/data from the local device 105. In yet another embodiment, each time the application executing on the local device 105 begins execution, the local device 105 can provide location information/data to the management server 115. In still another embodiment, the local device 105 may request content available for consumption and include location information/data in the request for content. Such location information/data can be provided, received, and validated using a variety of approaches and techniques that allow for validation of the location information/data as originating from a trusted source of the local device 105.

At some point, the local device 105 can collect appropriate location information/data (e.g., determine its location) using any of a variety of methods and techniques. For instance, the local device 105 can determine its location (e.g., collect location information) by determining its position relative to GPS satellites, via triangulation with various communication points (e.g., cellular towers or Wi-Fi access points), and/or via an Internet Protocol (IP) address associated with the device. In one embodiment, after determining its location (e.g., collecting location information), the local device 105 can provide at least a portion of the location information/data to the management server 115 for determination/identification of a broadcast area corresponding to the local device's 105 location (Block 705 of FIG. 7). As indicated, the location information/data may include zip code information/data, zoning information/data, city information/data, geographic area information/data, latitude information/data, longitude information/data, altitude information/data, geocode information/data, ephemeris information/data, cellular tower information/data, Wi-Fi access point information/data, IP address information/data, and/or the like.

In one embodiment, the location information/data can be provided by the local device 105 to the management server 115 using a variety of approaches and techniques that allow for validation of the location information/data as originating from a trusted source of the local device 105 (e.g., GPS, location modules 470). Such validation techniques may be useful because operating systems executing on certain local devices 105 (e.g., Android, iOS) can expose or provide access to location-determining solutions. Thus, certain applications running on local devices 105 may have access to location-determining solutions (e.g., GPS, location module 470), which can lead to tampering with the location information/data. By way of example, software shims can interpose themselves between local devices' 105 hardware and their location-determining solutions (e.g., GPS, location modules 470) and other applications. Such shims can then transparently intercept location information/data, alter the intercepted location information/data, handle requests themselves, and/or redirect certain operations. For example, a shim could cause a local device 105 to provide location information/data to the management server 115 that indicates that the local device 105 is located in New York City (regardless of the actual location of the device), which would thereby enable access to content or services that would normally be geo-restricted to the New York City area. Thus, validation methods and techniques can be used to validate the location information/data as originating from a trusted source of the local device 105 (e.g., GPS, location module 470, application executing on the local device 105).

i. Two-Way Encryption

In one embodiment, in response to requests for program information or content from the local device 105, the management server 115 can request location information/data from the local device 105. In such an embodiment, the management server 115 can encrypt requests for location information/data using various encryption techniques, including asymmetric encryption (including RSA and Diffie-Hellman encryption). For example, in one embodiment, the management server 115 can encrypt the request for location information/data to the local device 105 using the management server's 115 own private key, which can be decrypted (e.g., validated) by the local device 105 (e.g., GPS, location module 470, application executing on the local device 105) using the corresponding public key accessible via an appropriate key registry. By encrypting the request for location information/data, the local device 105 can validate the request as actually originating from the management server 115 (e.g., a trusted source). Additionally, the management server 115 can encrypt the request for location information/data using the local device's 105 public key that is accessible via an appropriate key registry. With this second encryption, only the local device 105 can decrypt the request for location information/data from the management server 115. In other words, this two-way encryption allows the local device 105 to validate the request as originating from the management server 115 (e.g., a trusted source), while also preventing other devices from decrypting the request for location information/data from the management server 115.

In one embodiment, after receiving and validating the request for location information/data from the management server 115, the local device 115 can obtain location information/data via, for example, the location-determining solution (e.g., GPS, location module 470). The location-determining solution (e.g., GPS, location module 470) can obtain the appropriate location information/data and encrypt the same for later validation by the management server 115. Similar to as described previously, the local device 105 (e.g., GPS, location module 470, application executing on the local device 105) can encrypt the location information/data using the local device's 105 own private key, which can be decrypted (e.g., validated) by the management server 115 using the corresponding public key accessible via an appropriate key registry. By encrypting the location information/data, the management server 115 can use the corresponding public key to later validate the location information/data as originating from, for example, the location-determining solution (or other appropriate solution) of the local device 105 (e.g., a trusted source of the local device 105). Additionally, the local device 105 (e.g., GPS, location module 470, application executing on the local device 105) can encrypt the location information/data using the management server's 115 public key that is accessible via an appropriate key registry. This second encryption only allows the management server 115 to decrypt the location information/data provided by the local device 105. Thus, this two-way encryption allows the management server 115 to validate the location information/data as actually originating from the location-determining solution (or other appropriate solution) of the local device 105 (e.g., a trusted source of the local device 105), while also preventing other devices from decrypting the location information/data provided by the local device 105.

As indicated, in another embodiment, the local device 105 can provide location information/data to the management server 115 even in the absence of a request for the location information/data. For example, each time the application executing on the local device 105 (e.g., local device 105) requests program information or content, the local device 105 (e.g., GPS, location module 470, application executing on the local device 105) can provide the appropriate location information/data along with the request. In such an embodiment, the local device 105 (e.g., GPS, location module 470, application executing on the local device 105) can encrypt the location information/data using various encryption techniques. As described above, the location-determining solution (e.g., GPS, location module 470) can obtain the appropriate location information/data and encrypt the same for later validation by the management server 115. For instance, the local device 105 (e.g., GPS, location module 470, application executing on the local device 105) can encrypt the location information/data using the local device's 105 own private key, which can be decrypted (e.g., validated) by the management server 115 using the corresponding public key. Additionally, the local device 105 (e.g., GPS, location module 470, application executing on the local device 105) can encrypt the location information/data using the management server's 115 public key. Thus, as noted above, this two-way encryption allows the management server 115 to validate (e.g., properly decrypt) the location information/data as actually originating from, for example, the location-determining solution (or other appropriate solution) of the local device 105 (e.g., a trusted source of the local device 105), while also preventing other devices from decrypting the location information/data provided by the local device 105.

In one embodiment, the encryption by the local device 105 (e.g., GPS, location module 470, application executing on the local device 105) can be carried out at, for example, the hardware level to prevent other applications or processes on the local device 105 from tampering with the location information/data prior to providing it to the management server 115. This provides for an established trusted, secure manner to ensure that the location information/data provided by the local device 115 has not been improperly altered prior to being provided to the management server 115.

As will be recognized, embodiments of the present invention are not limited to the above-described approaches. Rather, a variety of asymmetric encryption techniques can be used to adapt to various needs and circumstances. Further, various symmetric and other encryption techniques (including Blowfish, Advanced Encryption Standard (AES), and Data Encryption Standard (DES)) can be used in place of, in addition to, and/or in combination with embodiments of the present invention.

ii. One-Way Encryption

In one embodiment, in response to requests for program information or content from the local device 105, the management server 115 can request location information/data from the local device 105. In such an embodiment, the management server 115 can encrypt the request for location information/data to the local device 105 using the management server's 115 own private key, which can be decrypted (e.g., validated) by the local device 105 (e.g., GPS, location module 470, application executing on the local device 105) using the corresponding public key accessible via an appropriate key registry. By encrypting the request for location information/data, the local device 105 can validate (e.g., properly decrypt) the request as actually originating from the management server 115 (e.g., a trusted source).

In one embodiment, after receiving and validating the request for location information/data from the management server 115, the local device 115 can obtain location information/data via, for example, the location-determining solution (e.g., GPS, location module 470). The location-determining solution (e.g., GPS, location module 470) can obtain the appropriate location information/data and encrypt the same for later validation by the management server 115. Similar to as described previously, the local device 105 (e.g., GPS, location module 470, application executing on the local device 105) can encrypt the location information/data using the local device's 105 own private key, which can be decrypted (e.g., validated) by the management server 115 using the corresponding public key accessible via an appropriate key registry. By encrypting the location information/data, the management server 115 can use the corresponding public key to later validate the location information/data as originating from, for example, the location-determining solution (or other appropriate solution) of the local device 105 (e.g., a trusted source of the local device 105).

As indicated, in another embodiment, the local device 105 can provide location information/data to the management server 115 even in the absence of a request for the location information/data. For example, each time the application executing on the local device 105 (e.g., local device 105) requests program information or content, the local device 105 (e.g., GPS, location module 470, application executing on the local device 105) can provide the appropriate location information/data along with the request. In such an embodiment, the local device 105 (e.g., GPS, location module 470, application executing on the local device 105) can encrypt the location information/data using various encryption techniques. As described above, the location-determining solution (e.g., GPS, location module 470) can obtain the appropriate location information/data and encrypt the same for later validation by the management server 115. For instance, the local device 105 (e.g., GPS, location module 470, application executing on the local device 105) can encrypt the location information/data using the local device's 105 own private key, which can be decrypted (e.g., validated) by the management server 115 using the corresponding public key. This one-way encryption allows the management server 115 to validate the location information/data as actually originating from, for example, the location-determining solution (or other appropriate solution) of the local device 105 (e.g., a trusted source of the local device 105).

In one embodiment, the encryption by the local device 105 (e.g., GPS, location module 470, application executing on the local device 105) can be carried out at, for example, the hardware level to prevent other applications or processes on the local device 105 from tampering with the location information/data prior to providing it to the management server 115. This provides for an established trusted, secure manner to ensure that the location information/data provided by the local device 115 has not been improperly altered prior to being provided to the management server 115.

As will be recognized, embodiments of the present invention are not limited to the above-described approaches. Rather, a variety of asymmetric encryption techniques can be used to adapt to various needs and circumstances. Further, various symmetric and other encryption techniques (including Blowfish, AES, and DES) can be used in place of, in addition to, and/or in combination with embodiments of the present invention.

b. Broadcast Area Determination/Identification

In one embodiment, after receiving the location information/data from the local device 105 and validating the location information/data as originating from a trusted source of the local device 105 (Block 805 of FIG. 8), the management server 115 (e.g., via the location module 470) can use the location information/data from the local device 105 to determine/identify the broadcast area (e.g., DMA, zip code, block group, census tract, and government-established area/zone) associated with the location information/data (Block 810 of FIG. 8). To do so, in one embodiment, the management server 115 can translate the location information/data into a broadcast area designation by using, for example, a database storing cartographic layers/levels of the various broadcast areas. For example, if a local device 105 provides location information/data that identifies the location of the local device 105 as being in (or proximate) Fayette, Iowa, the management server 115 may determine/identify the corresponding broadcast area as broadcast area 637 (i.e., the Cedar Rapids-Waterloo-Iowa City-Dubuque broadcast area). Such a determination may be made via, for example, shortest distance algorithms determining/identifying the closest broadcast station and/or the closest broadcast station of a specific broadcast affiliate (e.g., the closest CBS station or tower). As will be recognized, a variety of other approaches and techniques can be used to determine/identify the appropriate broadcast area (e.g., DMA, zip code, block group, census tract, and government-established area/zone) for a local device 105.

In various embodiments, by determining the broadcast area in which a local device 105 is located, the management server 115 (and/or local device 105 or other computing entities) can determine/identify the channels (or other offerings) to which the local device 105 and remote device 120 have access rights (e.g., based on the local device's 105 location). For example, after determining/identifying the broadcast area, the management server 115 can determine/identify the broadcast stations (and/or corresponding broadcast rights holder) available in the broadcast area. For example, the management server 115 can determine/identify the broadcast stations shown in Table 1 as being associated with the Cedar Rapids-Waterloo-Iowa City-Dubuque broadcast area (e.g., broadcast area 637).

TABLE 1

| BROADCAST STATION | AFFILIATION |
|---|---|
| KCRG | ABC |
| KFXA | FOX |
| KFXB | FOX |
| KGAN | CBS |
| KIIN | PBS |
| KPXR | ION |
| KRIN | PBS |
| KWKB | The CW |
| KWWF | AMG TV |
| KWWL | NBC |

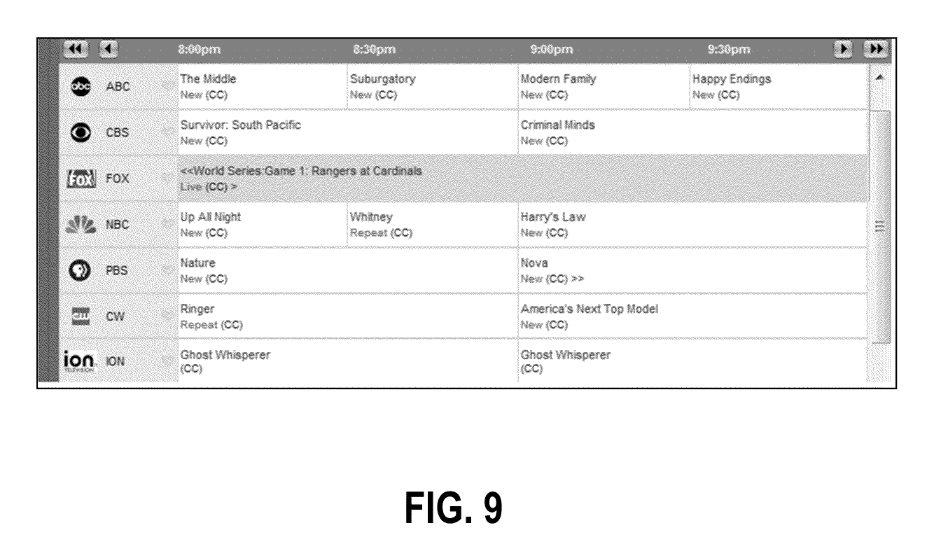

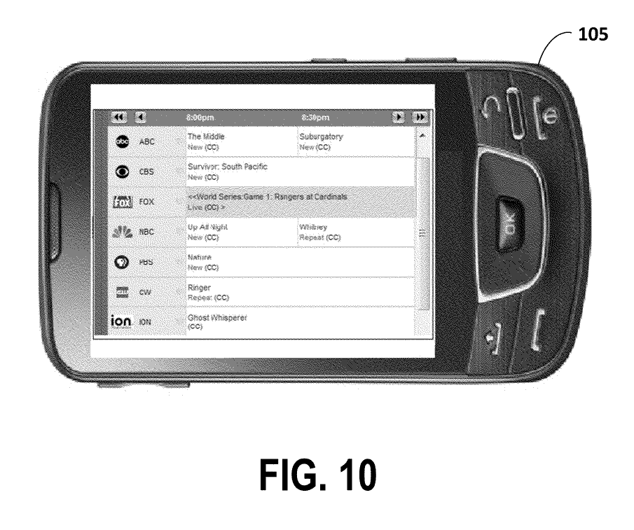

In embodiment, after determining/identifying the broadcast stations (and/or corresponding broadcast rights holder) for the broadcast area, the management server 115 can provide program information (to the local device 105 and/or remote device 120) for the broadcast area in which the local device 105 is located (Block 815 of FIG. 8). As shown in FIGS. 9 and 10, the program information may include program guides and/or program listings of live content (including linear content) and/or on-demand content, for example, that are available for consumption via the local device 105 and/or remote device 120. For instance, as seen in these figures, this exemplary program information includes content available during the 8:00 pm and/or 9:00 pm hours on ABC, CBS, FOX, NBC, PBS, The CW, and ION.

In one embodiment, the management server 115 may only provide program information for broadcast stations (e.g., ABC, CBS, FOX, NBC, PBS, The CW, ION) that have registered for such services with an independent third party operating the management server 115, such as Syncbak. In another embodiment, program information for all broadcast stations (e.g., ABC, CBS, FOX, NBC, PBS, The CW, ION, AMG TV) associated with the broadcast area can be provided regardless of their affiliation with the independent third party operating the management server 115 (e.g., Syncbak). In yet another embodiment, as indicated, a broadcaster may operate the management server 115 and therefore only provide program information for its station (e.g., FOX). The local device 105 and/or remote device 120 can receive, refresh, and/or update such program information on a periodic basis, regular basis, continuous basis, and/or in response to certain triggers (e.g., searches related to content) through a variety of approaches and techniques (Block 710 of FIG. 7).

In one embodiment, after determining/identifying the appropriate broadcast area, broadcast stations, and/or program information, the management server 115 can store the same in association with the user's account. For example, the management server 115 may store an indication that a particular user account is associated with broadcast area 637 (e.g., the user account has access rights to the content from broadcasters in broadcast area 637). In another embodiment, the management server 115 may store an indication that the user account is associated with broadcasters KCRG, KFXA, KFXB, KGAN, KIIN, KPXR, KRIN, KWKB, KWWF, and KWWL (e.g., the user account has access rights to the content from these broadcasters).

In various embodiments, the described operations and processes allow the physical location of the local device 105 to be established to determine the content the user is permitted to receive. As will be recognized, a variety of other approaches and techniques can be used to adapt to various needs and circumstances.

3. Content Access for Local Device

In one embodiment, a user (e.g., operating a local device 105) can access content from a broadcaster in a variety of ways. For instance, a local device 105 located in Fayette, Iowa, can access OTA content in the Cedar Rapids-Waterloo-Iowa City-Dubuque broadcast area by adjusting its tuner to the appropriate frequency. The content may include television broadcasts, television programs, movies, datacasts, music, images, videos, text, webpages, and/or the like.

In another embodiment, a user (e.g., operating a local device 105) can access content from a broadcaster via a network such as the Internet (any other wired or wireless network). To do so, a user (e.g., operating a local device 105) may select content from program information, such as the program guide or program listing shown in FIG. 10. For example, a user can (e.g., operating a local device 105) select or click on text, a graphic, or a hyperlink in the program information to access the corresponding content. Such an action may generate a request for the content (Block 715 of FIG. 7). In one embodiment, the request for content may comprise information that can be used to uniquely identify the user and/or local device 105. For example, in one embodiment, the request for content may include user information and/or a local device ID.

Similarly, a user (e.g., operating a local device 105) can perform a search for content. To do so, a user (e.g., operating a local device 105) may initiate a search for content via an appropriate interface by entering search terms. For example, the user may enter “X Factor” as the search terms. In response, the user (e.g., operating a local device 105) can be provided with text, a graphic, or a hyperlink to access the X Factor via the appropriate broadcaster. Such an action may generate a request for the content. As indicated, the request for content may comprise information that can be used to uniquely identify the user and/or local device 105.

The local device 105 may transmit the request to the management server 115 and/or the broadcaster (e.g., to a broadcast server). In one embodiment, the request for content is received via the management server 115 (Block 820 of FIG. 8). The request for content may include location information/data in a format that can be validated. As discussed, the management server 115 may be operated by (a) a broadcaster or (b) a party independent of a broadcaster. Thus, the request for content may be received, for example, by the broadcaster or the independent third party. In response to (e.g., after) receiving the request for content, the management server 115 may determine whether the requested content is content for which the user (e.g., local device 105) has access rights based on, for example, the local device's 105 location (Block 825 of FIG. 8). To do so, the management server 115 may use the user information and/or local device ID provided in the request to access the corresponding user account. By accessing the corresponding user account, the management server 115 (e.g., via the content module 460) can determine whether the user (e.g., local device 105) has access rights to the requested content. Such a determination may be made by identifying the broadcast area, broadcasters, and/or program information to which the user has access rights as indicated via the user account.

In response to (e.g., after) a determination that the user (e.g., local device 105) has access rights to the requested content, the management server 115 can allow transmission of the content to the local device 105 (Block 830 of FIG. 8). However, in response to (e.g., after) a determination that the user does not have access rights to the requested content, the management server 115 may not allow transmission of the content to the local device 105 (Block 830 of FIG. 8).

The content can be transmitted to the local device 105 in a variety of ways. For example, in one embodiment, the management server 115 can be used to transmit the content from the broadcaster to the local device 105 via the Internet (or other wired or wireless network). In another embodiment, the management server 115 can transmit a notification to the broadcaster to provide the specified content to the local device 105 via the Internet (or other wired or wireless network), bypassing the management server 115 for distribution of the content. As indicated in Block 720 of FIG. 7, the local device 105 can receive the requested content and display, play, or otherwise provide the same and/or make accessible via the local device 105.

In one embodiment, the local device 105 may access content (e.g., via a user operating the local device 105) that is currently being broadcast (e.g., via an OTA broadcast, a DBS broadcast, and/or a cable broadcast). For example, the local device may access (e.g., via a user operating the local device 105) the television show “The X Factor” 35 minutes after The X Factor broadcast began. In this example, the management server 115 and/or broadcast system 100 may allow the local device 105 to receive the content (e.g., the television show The X Factor) via a network such as the Internet (a) that is currently being broadcast or (b) from the beginning of the show The X Factor. As will be recognized, a variety of other approaches and techniques may also be used for distributing content to local devices 105.

In one embodiment, broadcasters may also enter into agreements to distribute other content to users (e.g., devices) over the Internet (or other wired or wireless network) within or associated with the broadcaster's broadcast area. For example, KCRG-TV9 may enter into an agreement with ESPN to distribute ESPN's live content (e.g., content normally only available via a subscription for satellite or cable services) over the Internet (or other wired or wireless network) to users (e.g., devices) within or associated with KCRG-TV9's broadcast area. Additionally, broadcasters such as KCRG-TV9 may also require a subscription (and fee) to receive ESPN's live content via the Internet (or other wired or wireless network) in KCRG-TV9's broadcast area. In addition to providing such content, the broadcaster may provide VOD content, pay-per-view (PPV) content, and a variety of other content via the Internet (or other wired or wireless network) to users (e.g., devices). In various embodiments, these concepts may allow broadcasters to distribute an unlimited amount of content (e.g., channels) to local devices 105 via a network such as the Internet while complying with geographic broadcast area limitations and/or restrictions. These embodiments can be further used to create virtual broadcast boundaries that, for example, track cable and/or broadcast area boundaries (e.g., DMAs, zip codes, block groups, census tracts, and government-established areas/zones).

5. Content Access for Remote Device

As indicated, the term remote device may refer to, for example, a device located outside a specific broadcast area when attempting to access content associated with the broadcast area (e.g., a device located outside a broadcaster's broadcast area when attempting to access the broadcaster's content). Although, in certain embodiments, the remote device 120 may also be located within a broadcaster's broadcast area when attempting to access the broadcaster's content. For example, a remote device 120 may be a user's mobile phone, laptop, or television that, at various times, may be within or outside a specific broadcast area.

In one embodiment, after determining that the local device 105 is within or proximate a particular broadcast area, the remote device 120 may be able access the broadcaster content via the Internet, for example, when outside the broadcast area (e.g., DMA, zip code, block group, census tract, and government-established area/zone). To do so, the remote device 120 can first be registered with the local device 105 and/or the management server 115 (Block 700 of FIG. 7). In one embodiment, registration may include inputting (e.g., via a user operating a device) user information and/or information associated with the remote device 120 via a module, program, or application that was downloaded or preinstalled on the remote device 120. In another embodiment, registration may include inputting (e.g., via a user operating a device) user information and/or information associated with the remote device 120 via a webpage of an independent third party or broadcaster. The information associated with the remote device 120 may include information that uniquely identifies the user or remote device 120, such as a SIM number, MAC address, IMSI number, IP address, MEID, and/or other device identifier. Such information may be stored, for example, by the management server 115 in association with a user's account and/or by a corresponding local device 105.

In one embodiment, after the remote device 120 has been registered, the remote device 120 may receive program information for the broadcast area in which the local device 105 is located (Block 710 of FIG. 7). As previously described, the program information may include program guides and/or program listings of live content (including linear content) and/or on-demand content, for example, that are available for consumption via the remote device 120. For instance, as seen in these figures, this exemplary program information includes content available during the 8:00 pm and/or 9:00 pm hours on ABC, CBS, FOX, NBC, PBS, The CW, and ION. As will be recognized, though, content may be accessed in a variety of other ways as well.

In one embodiment, a user (e.g., operating a remote device 120) can access content from a broadcaster via a network such as the Internet (any other wired or wireless network). To do so, a user (e.g., operating a remote device 120) may select content from program information, such as the program guide or program listing shown in FIG. 10. For instance, a user can (e.g., operating a remote device 120) select or click on text, a graphic, or a hyperlink in the program information to access the corresponding content. Such an action may generate a request for the content (Block 715 of FIG. 7). In one embodiment, the request for content may comprise information that can be used to uniquely identify the user and/or the remote device 120. For example, in one embodiment, the request for content may include user information and/or a remote device ID. The request for content may include location information/data in a format that can be validated.

The remote device 120 may transmit the request to the local device 105, the management server 115, and/or the broadcaster (e.g., to a broadcast server). In one embodiment, the request for content is transmitted to and received by the management server 115. In response to (e.g., after) receiving can validating the request for content (Block 820 of FIG. 8), the management server 115 (e.g., via the content module 460) may determine whether the requested content is content for which the user (e.g., remote device 120) has access rights based on, for example, the corresponding local device's 105 location (Block 825 of FIG. 8). To do so, the management server 115 may use the user information and/or remote device ID provided in the request to access the corresponding user account. By accessing the corresponding user account, the management server 115 can determine whether the user (e.g., remote device 120) has access rights to the requested content. As indicated, such a determination may be made by identifying the broadcast area, broadcasters, and/or program information to which the user has access rights as indicated in the user account.

In response to (e.g., after) a determination that the user (e.g., remote device 120) has access rights to the requested content, the management server 115 can allow transmission of the content to the remote device 120 (Block 830 of FIG. 8). However, in response to (e.g., after) a determination that the user does not have access rights to the requested content, the management server 115 may not allow transmission of the content to the remote device 120 (Block 830 of FIG. 8).

The content can be transmitted to the remote device 120 in a variety of ways. For example, in one embodiment, the management server 115 can be used to transmit the content from the broadcaster to the remote device 120 via the Internet (or other wired or wireless network). In another embodiment, the management server 115 can transmit a notification to the broadcaster to provide the specified content to the remote device 120 via the Internet (or other wired or wireless network), bypassing the management server 115 for distribution of the content. As indicated in Block 720 of FIG. 7, the remote device 120 can receive the requested content and display, play, or otherwise provide the same and/or make accessible via the remote device 120.

In various embodiments, because the physical location of the local device 105 has been established, the remote device 120 can receive content based on the local device's 105 location. In various embodiments, this approach allows the broadcaster or third party to identify content (or broadcasters and/or broadcast areas from which) the user (e.g., remote device 120) is permitted to receive via the Internet (or other wired or wireless network). For example, a user may take her mobile phone or laptop on a business trip or vacation outside the broadcaster's broadcast area. In such a case, the described operations and processes can allow the user (or other parties) to access content (e.g., stream a newscast or television program) from a broadcaster even when outside the broadcaster's broadcast area.

In one embodiment, the user may be limited in the number of remote devices 120 that can be registered for access to content. For example, the user may only be able to register five devices with the local device 105. In various embodiments, this may limit fraud attempts by users in registering friends' or relatives' remote devices 120 for access to content outside a specific broadcast area.

IV. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for receiving content available for consumption, the method comprising:
providing, via an electronic device, location information associated with an electronic device, wherein the location information (a) identifies the location of the electronic device, (b) is used to identify a broadcast area associated with the electronic device, the broadcast area defining a geographic region in which each of a plurality of broadcasters has the right to provide corresponding content, and (c) is provided to allow validation as originating from a trusted source of the electronic device;
generating, via the electronic device, a request to receive content provided by one of the plurality of broadcasters that has the right to provide the content in the broadcast area; and
receiving, via the electronic device, the requested content after the broadcast area associated with the electronic device is identified.

2. The method of claim 1 further comprising, after identifying the broadcast area, receiving program information for the broadcast area.

3. The method of claim 1, wherein the location information is identified at least in part by using a global positioning satellite system.

4. The method of claim 1, wherein the location information is identified at least in part by using triangulation.

5. The method of claim 1 further comprising registering the electronic device for broadcast area identification.

6. The method of claim 1, wherein the broadcast area is selected from the group consisting of a designated market area, a zip code, a block group, and a government-established area.

7. An apparatus comprising at least one processor and at least one memory including computer program code, the at least one memory and the computer program code configured to, with the processor, cause the apparatus to at least:
provide location information associated with the apparatus, wherein the location information (a) identifies the location of the apparatus, (b) is used to identify a broadcast area associated with the apparatus, the broadcast area defining a geographic region in which each of a plurality of broadcasters has the right to provide corresponding content, and (c) is provided to allow validation as originating from a trusted source of the apparatus;
generate a request to receive content provided by one of the plurality of broadcasters that has the right to provide the content the broadcast area; and
receive the requested content after the broadcast area associated with the apparatus is identified.

8. The apparatus of claim 1, wherein the memory and computer program code are further configured to, with the processor, cause the apparatus to, after identifying the broadcast area, receive program information for the broadcast area.

9. The apparatus of claim 1, wherein the location information is identified at least in part by using a global positioning satellite system.

10. The apparatus of claim 1, wherein the location information is identified at least in part by using triangulation.

11. The apparatus of claim 1, wherein the memory and computer program code are further configured to, with the processor, cause the apparatus to register the electronic device for broadcast area identification.

12. The method of claim 1, wherein the broadcast area is selected from the group consisting of a designated market area, a zip code, a block group, and a government-established area.

13. A computer program product for receiving content available for consumption, the computer program product comprising at least one non-transitory computer-readable storage medium having computer-readable program code portions stored therein, the computer-readable program code portions comprising:
an executable portion configured to provide location information associated with an electronic device, wherein the location information (a) identifies the location of the electronic device, (b) is used to identify a broadcast area associated with the electronic device, the broadcast area defining a geographic region in which each of a plurality of broadcasters has the right to provide corresponding content, and (c) is provided to allow validation as originating from a trusted source of the electronic device;
an executable portion configured to generate a request to receive content provided by one of the plurality of broadcasters that has the right to provide the content in the broadcast area; and
an executable portion configured to receive the requested content after the broadcast area associated with the electronic device is identified.

14. The computer program product of claim 13 further comprising an executable portion configured to, after identifying the broadcast area, receiving program information for the broadcast area.

15. The computer program product of claim 13, wherein the location information is identified at least in part by using a global positioning satellite system.

16. The computer program product of claim 13, wherein the location information is identified at least in part by using triangulation.

17. The computer program product of claim 13 further comprising an executable portion configured to register the electronic device for broadcast area identification.

18. The computer program product of claim 13, wherein the broadcast area is selected from the group consisting of a designated market area, a zip code, a block group, and a government-established area.
